(19) United States
(12) Patent Application Publication
(10) Pub. No.: US 2026/0241517 A1
(43) Pub. Date: Aug. 20, 2026

(54) VARIABLE CLAMP ADAPTER

(71) Applicant: wolfcraft GmbH, Kempenich (DE)

(72) Inventor: Winfried EBERT, Weibern (DE)

(73) Assignee: wolfcraft GmbH, Kempenich (DE)

(21) Appl. No.: 19/159,683

(22) PCT Filed: Mar. 6, 2024
(86) PCT No.: PCT/EP2024/055802

§ 371 Date: Aug. 26, 2025

(30) Foreign Application Priority Data
Mar. 10, 2023 (DE) 10 2023 105 996.3

(51) Int. Cl. B25B 5/06; B25B 5/00; B25B 5/16

(52) U.S. Cl. CPC B25B 5/068; B25B 5/003; B25B 5/16

(57) ABSTRACT

A device includes a housing which has an insertion channel extending in the axial direction for inserting a free end of a slide bar of a clamp, wherein the slide bar can be axially secured to the housing via a lock element which can be brought into a release position, in which the slide bar can be removed from the device. The device has a stabilizing element having an insertion opening and a stabilizing flank arrangement which is adjacent to the insertion opening and is adapted to the cross-section contour of the slide bar, for supporting surface portions of the slide bar. The stabilizing element is fastened to the housing in a rotatable manner and has several angle-offset stabilizing flank arrangements which are adapted to the outline contours of different slide bars.

### FIELD OF TECHNOLOGY

The invention relates to device with a housing, which has an insertion channel running in an axial direction for inserting a free end of a slide bar of a clamp, wherein the slide bar can be axially secured to the housing by means of a lock element, which can be brought into a release position, in which the slide bar can be removed from the device, with a stabilizing element having an insertion opening and adjoining the latter in the insertion direction and a stabilizing flank arrangement, which is adapted to the cross-section contour of the slide bar, for the abutment of surface portions of the slide bar.

### PRIOR ART

The WO 2014/118379 A1 describes a device of this type. The housing therein has two insertion openings facing away from one another with a respective adjoining insertion channel for inserting a free end of a respective bar, wherein a stabilizing element can in each case be inserted into the insertion openings. The stabilizing element has an insertion opening with stabilizing flanks, which are adapted to the rectangular cross-section contour of a slide bar and which reduce the free opening cross section of the insertion channel of the housing. A slide bar with a smaller cross-section contour can thus be inserted into the insertion channel. The stabilizing element has a stabilizing flank arrangement, which is adapted to the cross-section contour of only one slide bar. When using slide bars with cross-section contours, which differ from one another, the stabilizing element has to be exchanged. As a result, the operator has to always use a plurality of different stabilizing elements.

A clamping jaw, which can be released on an end of a slide bar of a clamp with a locking device and which has an insertion opening, which is adapted only to one cross-section contour, is known from the DE 101 31 966 A1.

The DE 20 2022 101 658U 1 , US 2008/0256775 A1, DE 20 2009 013 416 U1and US 2017/0043453 A1 also belong to the prior art.

### SUMMARY OF THE INVENTION

The invention is based on the object of further developing one of the generic above-described devices in a manner advantageous for its use and to expand the application spectrum thereof.

The object is solved by means of the invention specified in the claims.

The subclaims are not only advantageous further developments of the invention characterized in the independent claims, but also represent independent solutions of the object.

It is initially and essentially provided to use the device as adapter for cross-section contours, which differ from one another, of slide bars. For this purpose, the stabilizing element has several stabilization flank arrangements, which are adapted to cross-section contours, which differ from one another, of slide bars. The stabilization flank arrangements can form broadside flanks and narrow side flanks for the at least partial engaging around of a narrow side of the slide bar. Two stabilizing flank arrangements located diametrically opposite one another hereby in each case engage around a narrow side of the slide bar. The stabilizing flank arrangements abut with only slightly distance against the narrow sides and broadsides of the slide bar, in order to absorb torques, which are generated by means of a clamping force exerted on the clamp, on the slide bar and to prevent a wobbling of the latter. The different stabilizing flanks can be arranged angularly offset from one another and can optionally be brought into an aligned position with the insertion channel of the housing by rotating the stabilizing element. This means that the stabilizing element, in conjunction with the housing, can be brought into other positions or can be adjusted. This takes place with as little movement play as possible, in order to avoid a wobbling of the slide bar, which is inserted into the device. Alternatively, the stabilizing element can also be capable of being re-plugged, for example removed from the housing and inserted in another position again. The stabilizing flank arrangements can delimit free surfaces with different widths and/or lengths, in particular rectangular free surfaces. A stabilizing element can have several individual free surfaces of different sizes, in particular three, which are arranged so as to be angularly offset by 60°. The preferably several free surfaces can overlap in such a way that a total surface forms, which has the shape of a star, the arms of which end in a blunt manner and have different lengths. The stabilizing flanks can form a shape, which has an oval cross section, wherein two broadside flanks running parallel in each case adjoin a narrow side flank. The broadside flanks do not necessarily have to run parallel to one another. The cross-section shape can also be a “round” U-shape, the two U-legs can run in a straight line or curved and can transition into the U-web by forming a bend. However, they can also transition without bend into the in particular rounded U-web. The broadside flanks have broadside flank ends, which face the axis of the insertion opening of the housing and which are connected to the broadside flank ends of adjacent stabilizing flank arrangements. The housing can have two insertion channels, which face away from one another, each with a stabilizing element for connecting two slide bars, wherein the slide bars can have the same cross-section contour or cross-section contours, which differ from one another. Identically constructed stabilizing elements can be inserted or those, whose pairs of stabilizing flanks have a distance measurement, which the other stabilizing element does not have. Another exemplary embodiment, however, can provide only one stabilizing element, for example as clamping jaw, as described in the DE 101 31 966 A1. In order to mark the stabilizing flanks, which are adapted to different cross-section contours of slide bars, the front side of the stabilizing element has markings, in particular numbers, which specify the distance of two stabilizing flank arrangements forming a pair. A flange, in particular an insertion flange, which forms a bearing recess, in which the stabilizing element is rotatably mounted or is rotatably fastened, can adjoin the housing. The stabilizing element can be adjusted by applying a torque to a handling zone, which extends over the edge of the insertion flange. It can in particular be rotated or adjusted between rotational or locked positions, respectively. In the locked positions, the stabilizing flanks are in an angular position, which provides for an insertion of the free end of a slide bar all the way into the insertion channel of the housing. Locking depressions, which are arranged on a portion of the stabilizing element adjoining the handling zone so as to be spaced apart from one another in even angular distribution in the circumferential direction, can be provided as locking means. The portion can provide for a cylindrical bearing surface, which is adjoined by a cylinder portion, which forms a locking portion and on which the locking depressions can be located. In other exemplary embodiments, the stabilizing element can also be fastened to the jacket surface of the insertion flange by means of locking means in different rotational positions or directly to the housing. Hooks arranged on the inner side or the outer side of the bearing recess can engage in an elastically resettable manner with the locking depressions, which effect an azimuthal locking. On the front side facing in the direction of the housing, the hooks have a stop surface, which, in the inserted state, is acted on by a mating stop surface of an abutment shoulder formed on the edge of the cylinder portion in the direction of the housing, so that the hooks axially secure the stabilizing element to the housing. A stabilizing ring, in particular a C-shaped snap ring, can furthermore engage around the hooks fastened to the bearing recess, so that an unintentional dissolving of the axial locking between the hooks and the locking depressions is prevented. The azimuthal locking, however, can be cancelled by applying a torque to the stabilizing element. The insertion flange has a circumferential groove, in which the stabilizing ring rests, namely in such a way that it acts on the hooks in the radial inwards direction. The stabilizing ring can consist of plastic. The plastic can be a soft plastic. However, the stabilizing ring can also consist of metal. The hooks can be tongues, which are integrally molded of the same material as the insertion flange and which have protrusions, which, on their ends, are directed towards the locking depressions. These protrusions have run-on slopes, which simplify the insertion of the stabilizing element into the bearing recess of the flange during the assembly of the device, in that a gliding of the hooks across the abutment shoulder into the locking depressions is made possible by means of the run-on slopes. The hooks fastened to the bearing recess are cut out from the wall of the insertion flange. U-shaped cut-outs, in which a hook is in each case arranged spaced apart from the inner edge of the cut-out, are located in the bearing surface portion of the stabilizing element. The portion of the stabilizing element adjoining the handling zone forms a cavity, which adjoins the insertion opening and through which the free end of the slide bar can be plugged. The cavity has an inner wall, which forms broadside walls and narrow side walls corresponding to the cross-section contour of the stabilizing flank arrangement. The stabilizing flank extends at least over a part of the axial length of the stabilizing element. In the locked position, the lock element has an effect, which axially secures the slide bar. A torque exerted on the device during the use of a clamp arrangement as intended is discharged into the device via the stabilizing flanks. For locking purposes, a locking bolt can be provided, which can enter into a locking opening of the slide bar. In the locked position, the lock element can cross the insertion channel of the housing. By actuating a pressure element, as disclosed in the DE 101 31 966 A1, the lock element can be brought into a release position. The pressure element is located in a recess in the housing and can be displaced into the recess against the reset force of a spring element. The pressure element is connected via an actuating pin to a carrier, which carries the lock element. The housing and the adjoining insertion flange as well as the stabilizing element can consist of plastic, wherein the individual parts can be pressed or can be manufactured using the injection molding process. Size information, which specifies the length of the cross-section surface of a slide bar in millimeters, can be attached to a front surface of the stabilizing element. In the case of the exemplary embodiment, it is 18 mm, 20 mm and 22 mm. Other exemplary embodiments have different cross-section lines.

### BRIEF DESCRIPTION OF THE DRAWINGS

Several exemplary embodiments of the invention are illustrated in the enclosed drawings and are explained below, in which:

FIG. 1 shows a view of a first exemplary embodiment according to the invention, wherein a stabilizing element 4, into which the slide bar 15 of a clamp is inserted, is in each case mounted in insertion flanges 2, which adjoin a housing 1;

FIG. 2 shows an enlarged illustration of the housing 1 according to FIG. 1 without slide bars 15 inserted in the stabilizing elements;

FIG. 3 shows a view onto the front side of the stabilizing element 4 according to the viewing direction III from FIG. 2, prepared for inserting a 20 mm wide slide bar into an insertion opening 5;

FIG. 4 shows an illustration according to FIG. 3, wherein the stabilizing element 4 is rotated clockwise by 60°, so that a 22 mm wide slide bar 15 can be inserted into the insertion opening 5;

FIG. 5 shows an illustration according to FIG. 3, wherein the stabilizing element 4 is rotated counter-clockwise by 60°, so that an 18 mm wide slide bar 15 can be inserted into the insertion opening;

FIG. 6 shows a rear view of the housing 1 without the slide bar 15 inserted into the stabilizing element 4;

FIG. 7 shows an enlarged and partially broken-open illustration of the insertion flange 2 adjoining the housing 1 without slide bar 15 inserted into the stabilizing element 4, wherein locking depressions 9 arranged adjacent to one another so as to be spaced apart from one another in the circumferential direction are visible on a portion of the stabilizing element 4 adjacent to a handling zone 11;

FIG. 8 shows a partially broken-open first exploded illustration of the housing 1 without stabilizing elements 4 mounted in the insertion flanges 2;

FIG. 9 shows a cross section according to the section line IX-IX in FIG. 2, but with inserted slide bar 15;

FIG. 10 shows a cross section according to the section line X-X in FIG. 2, wherein the lock element 7, in a locked position, crosses an insertion channel 6 of the housing 1;

FIG. 11 shows a partial view of a section along the line XI-XI in FIG. 2;

FIG. 12 shows an illustration according to FIG. 11, but with inserted slide bar 15, wherein the lock element 7, in the locked position, passes through an opening 16 of the slide bar 15 while crossing the insertion channel 6;

FIG. 13 shows an illustration according to FIG. 12, but with the lock element 7 brought into a release position by means of a displacement of the pressure element 19 into a recess 23;

FIG. 14 shows a longitudinal section according to the line XIV in FIG. 4;

FIG. 15 shows a perspective illustration of a second exemplary embodiment according to the invention without inserted slide bar 15, wherein a stabilizing ring 33 rests in the circumference groove 34 of the insertion flange 2;

FIG. 16 shows a section according to the sectional plane XVI in FIG. 15;

FIG. 17 shows a part of the section according to the sectional plane XVII in FIG. 15.

### DESCRIPTION OF THE EMBODIMENTS

The first exemplary embodiment according to the invention consists of a housing 1, which has two insertion channels 6 facing away from one another for inserting a respective free end of an essentially rectangular slide bar 15 of a clamp. The insertion channels 6 have a bottom formed by a bottom web 31. The free ends of the slide bar 15 can support themselves on this bottom. The insertion channels 6 can also be connected to one another. An insertion flange 2 in each case adjoins the insertion channels 6. The insertion flange 2 forms a bearing recess 3, in which a stabilizing element 4 is rotatably mounted.

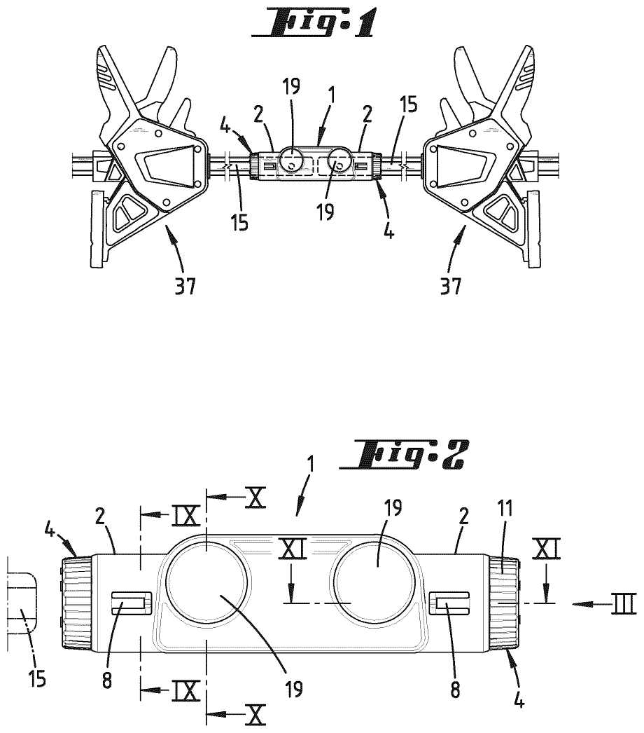

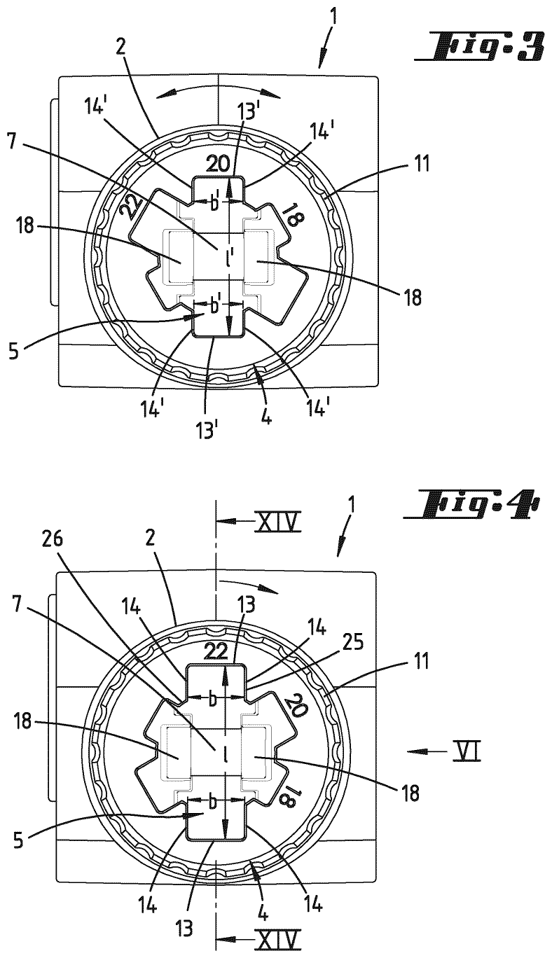

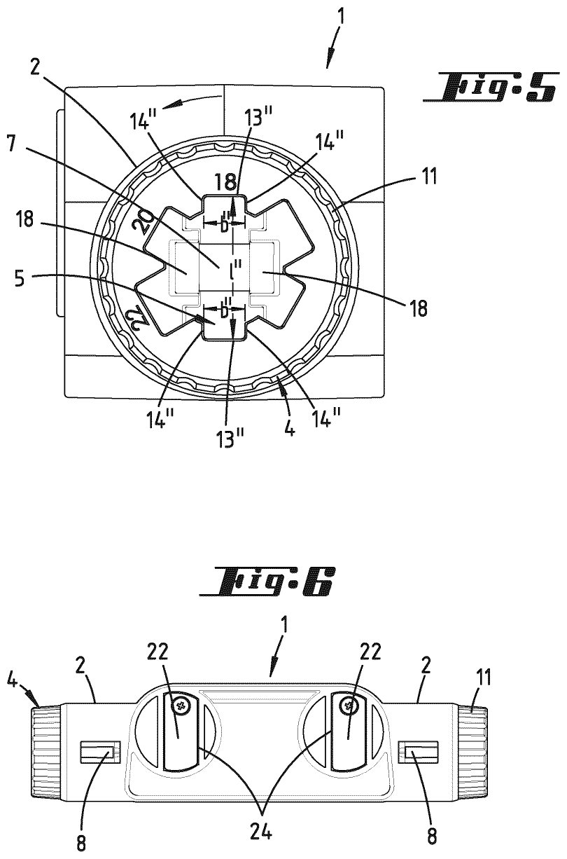

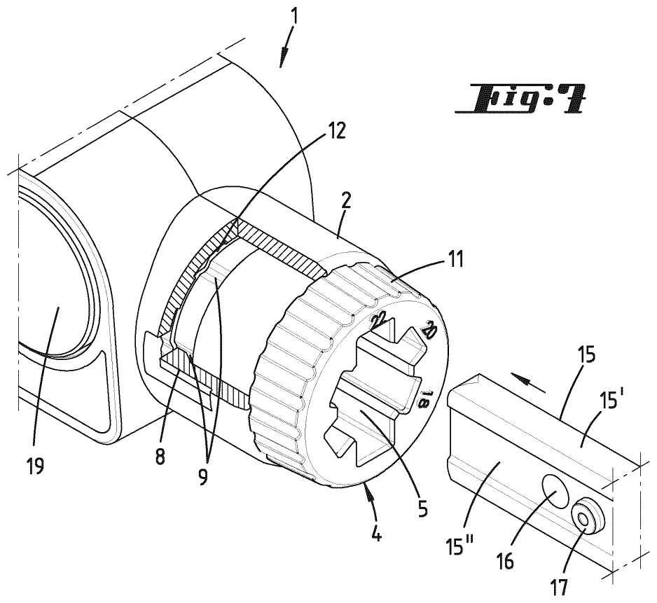

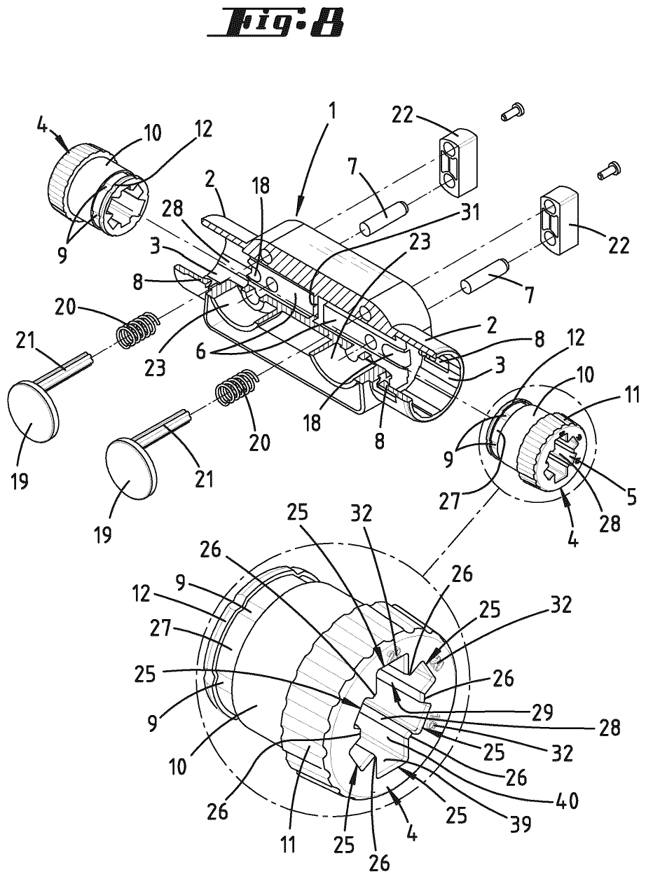

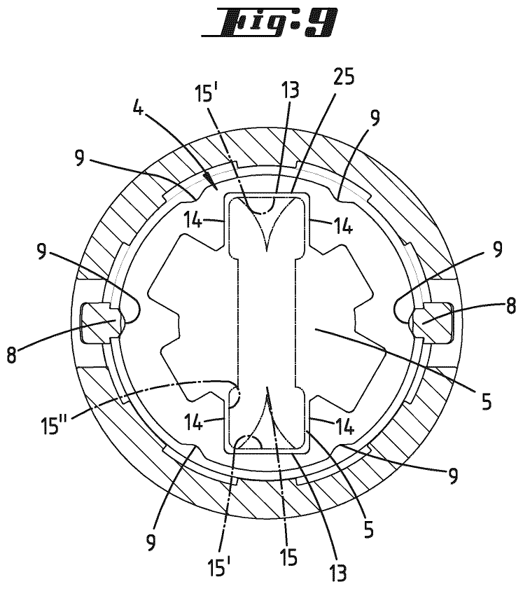

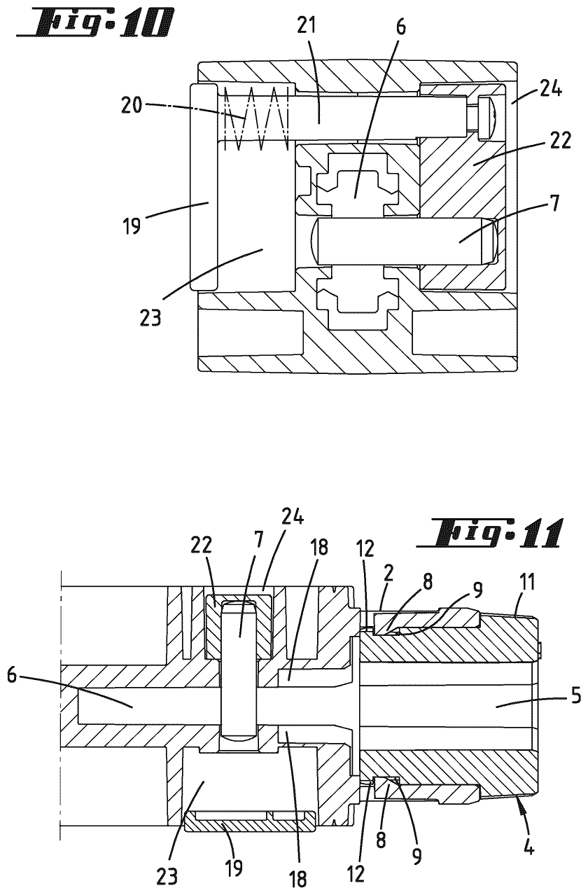

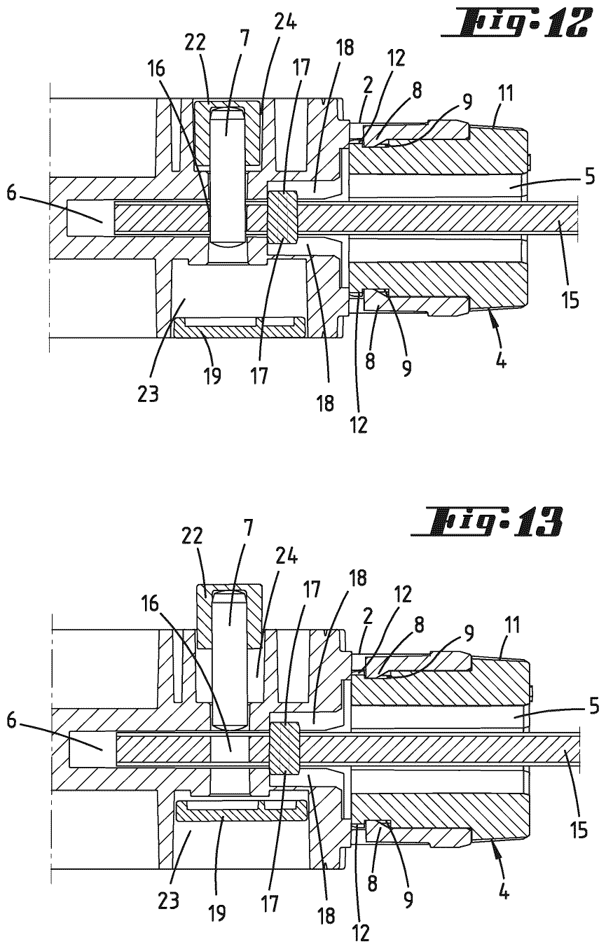

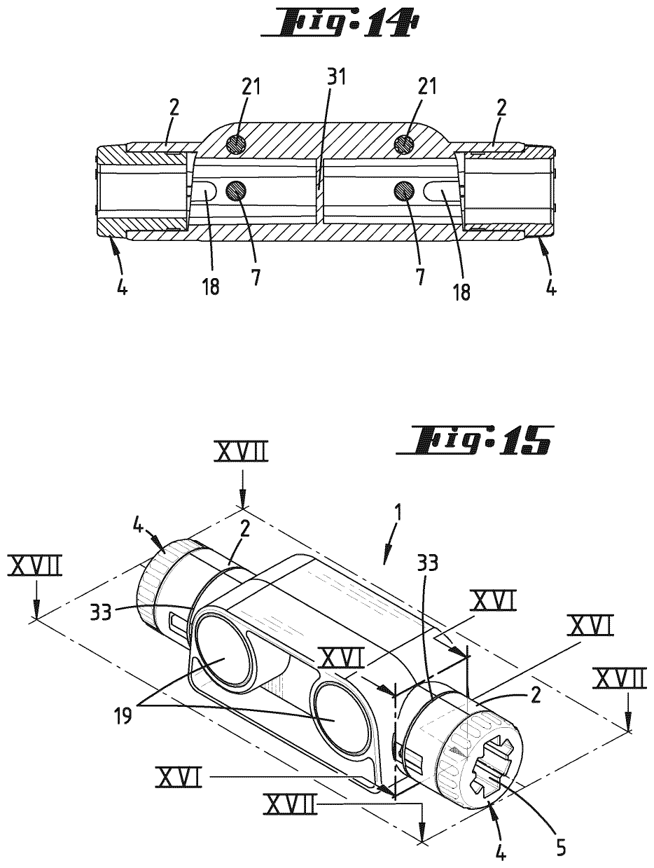

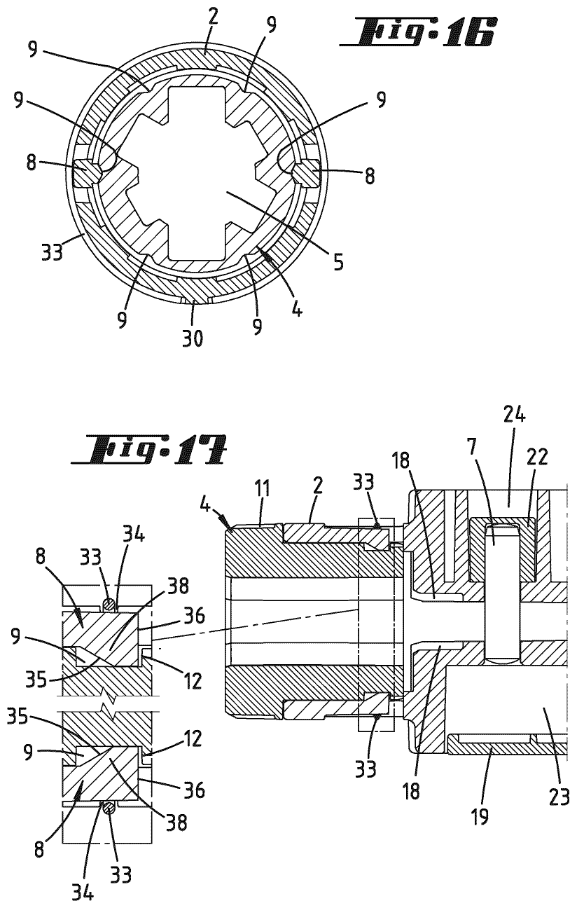

The stabilizing element 4 has an insertion opening 5, into which the free end of a slide bar 15 is inserted. In the inserted state, the free end of the slide bar is inserted all the way into the insertion channel 6 of the housing 1. There, the free end of the slide bar 15 is axially secured to the housing 1 by means of a ring element 7, which passes through an opening 16 of the free end of the slide bar 15. The device is illustrated in FIG. 1 with two inserted free ends of slide bars, which are each connected to clamping jaws. The lock elements 7 can absorb tractive forces.

On their front side facing away from the housing, the stabilizing elements 4 have stabilizing flank arrangements 25, which are adapted to different outline contours of slide bars. They form narrow side flanks 13, 13′, 13″ and broadside flanks 14, 14′, 14″, wherein the broadside flanks 14, 14′, 14″ have broadside flank ends 26, which face the axis of the insertion opening 5 of the housing 1 and which can be connected to the broadside flank ends 26 of adjacent stabilizing flank arrangements 25.

As illustrated in FIGS. 3, 4 and 5, the stabilizing flanks form an arrangement with a U-shaped cross section. Two broadside flanks 14, 14′, 14″, which in run parallel, hereby in each case adjoin a narrow side flank 13, 13′, 13″, which delimit rectangular free surfaces with different widths b (b′, b″) and/or lengths 1, 1′, 1″. The distance between two stabilizing flank arrangements 25, which form a pair, is marked by markings 32 located on the front side of the stabilizing element 4. The different sized free surfaces are arranged so as to be angularly offset from one another, preferably 3 by 60°, and can be brought into an aligned position with the insertion channel 6 of the housing 1 either by clockwise rotation as shown in FIG. 4, starting at the orientation illustrated in FIG. 3, or counter-clockwise as shown in FIG. 5.

The dimensions for the cross-sectional length of the slide bar 15 specified on the front side of the stabilizing element 4 are only exemplary. Other embodiments are suitable for slide bars, the cross section of which have a different length and a different width.

As illustrated in FIG. 9, two stabilizing flank arrangements 25 located diametrically opposite one another in the inserted state each have a narrow side 15′ of the slide bar 15. In order to absorb torques, which are generated by means of a clamping force exerted on the clamp, on the slide bar 15, the stabilizing flank arrangements 25 abut with only a slight distance against the narrow sides 15′ and broadsides 15″ of the slide bar 15.

The stabilizing element 4 is rotatably mounted in the bearing recess 3 of the insertion flange 2. A handling zone 11 extends over the edge of the insertion flange 2. By applying a torque to the handling zone 11, the stabilizing element 4 is adjusted between locked positions, in which the stabilizing flanks are in an angular position, which provide for the insertion of a free end of a slide bar 15. Locking depressions 9, which are arranged spaced apart from one another in even angular distribution in the circumferential direction on a cylinder portion 27 adjoining the handling zone 11 and a cylindrical bearing surface 10, are provided as locking means. Hooks 8, which engage in an elastically resettable manner with the locking depressions 9, are fastened to the bearing recess 3, whereby an azimuthal locking between stabilizing element 4 and insertion flange 2 is effected.

A bead-shaped abutment shoulder 12 is formed on the edge of the cylinder portion 27 in the viewing direction III illustrated in FIG. 2. In the locked position, a stop surface 36 located on the front side of the hooks 8 facing in the viewing direction III is acted on by a mating stop surface of the abutment shoulder 12, whereby the stabilizing element 4 is axially secured to the housing 1. The hooks 8 are tongues, which are integrally molded to the insertion flange 2 and which have protrusions 38, which are directed on their ends towards the locking depressions 9. Said protrusions have run-on slopes 35, by means of which a gliding of the hooks 8 across the abutment shoulder 12 into the locking depressions 9 is made possible, which simplifies the insertion of the stabilizing element 4 into the bearing recess 3 of the insertion flange 2 during the assembly of the device.

The abutment shoulder 12 formed as bead has depressions, which follow the locking depressions 9 in the axial direction.

U-shaped cut-outs, in which a hook 8 is in each case arranged spaced apart from the inner edge of the cut-out, are located in the wall of the insertion flange 2. However, the cut-outs can also have a different shape.

The cylindrical bearing surface 10 adjoining the handling zone 11 and the cylinder portion 27 form a cavity 28 on the insertion opening 5 of the stabilizing element 4. The cavity 28 has an inner wall 29, which forms broadside walls 39 and narrow side walls 40, which correspond to the cross-section contour of the stabilizing flank arrangements 25 and against which the narrow sides 15′ and the broadsides 15″ of the slide bar 15 can abut with slight play or directly in the inserted state. The stabilizing flank arrangements 25 extend at least over a part of the axial length of the stabilizing element 4.

The slide bar 15 is secured to the housing 1 by means of the lock element 7. The lock element 7 is fastened to a carrier 22. The carrier 22 is connected with an actuating pin 21, which crosses the insertion channel 6 of the housing 1, to a pressure element 19, in particular by means of a screw connection. The pressure element 19 is inserted in a recess 23 of the housing 1 and is acted on by a spring element 20. A pressure element arrangement of this type is disclosed in the DE 101 31 966 A1. Reference is made to the corresponding embodiments of the above-mentioned document.

By means of pressure on the pressure element 19, the latter is displaced into the recess 23 against the reset force of the spring element 20. If the pressure element 19 is brought into the release position illustrated in FIG. 13, the lock element 7 emerges completely from the insertion channel 6, so that either an already inserted slide bar 15 can be removed from the device or a slide bar 15 can be inserted. In the release position, the carriers 22 emerge from a recess 24 in the housing 1.

The pressure element 19 can have a circular cross section but other shapes, such as, for example, a square cross section, are also possible. In order to bring the lock element 7 into a release position, the pressure elements 7 have to be pushed into the recess 23.

In a further exemplary embodiment, a stabilizing ring 33, in particular a C-shaped snap ring, engages around the insertion flange 2 in the region of the hooks 8, which are fastened to the bearing recess 3. The stabilizing ring lies in a circumferential groove 34 of the insertion flange 2, namely in such a way that it acts on the hooks in the radial inwards direction, whereby an unintentional release of the axial locking between the hooks 8 and the locking depressions 9 is prevented.

On its free end, the slide bar 15 forms a protrusion 17, which, in the inserted state, enters into a slot 18 formed by the insertion channel 2.

The above remarks serve the purpose of explaining the inventions, which are captured as a whole by the application and which further develop the prior art at least by means of the following feature combinations, in each case also independently, whereby two, several or all of these feature combinations can also be combined, namely:

A variable clamp adapter, which is characterized in that the stabilizing element 4 has several stabilizing flanks 25, which are adapted to different cross-section contours of slide bars 15 and which can optionally be brought into an aligned position with the insertion channel 6 of the housing 1.

A variable clamp adapter, which is characterized in that the insertion opening 5 of the stabilizing element 4, which is rotatably fastened to the housing 1, has several angularly offset stabilizing flank arrangements 25, which are adapted to outline contours of different slide bars 15 and which delimit rectangular free surfaces with different widths b, b′, b″ and lengths 1, 1′, 1″.

A variable clamp adapter, which is characterized in that the stabilizing flank arrangement 25 forms narrow side flanks 13, 13′, 13″ and broadside flanks 14, 14′, 14″ for at least partially engaging around a narrow side 15′ of the slide bar 15.

A variable clamp adapter, which is characterized in that the stabilizing flank arrangement 25 is formed with a U-shaped cross section and two broadside flanks 14, 14′, 14″ running in parallel are in each case connected to a narrow side flank 13, 13′, 13″, wherein the broadside flanks 14, 14′, 14″ have broadside flank ends 26, which face the axis of the insertion opening 5 and which adjoin broadside flank ends 26 of adjacent stabilizing flank arrangements 25, wherein two stabilizing flank arrangements 25, which are located diametrically opposite one another, in each case engage around a narrow side 15′ and/or broadside 15″ of the slide bar 15.

A variable clamp adapter, which is characterized in that by a flange, on which the stabilizing element 4 is rotatably mounted, which is in particular an insertion flange 2 with a bearing recess 3, into which a portion of the stabilizing element 4 is inserted, wherein the stabilizing element 4 is held in different rotational positions by means of locking means 8, 9, 12.

A variable clamp adapter, which is characterized in that the stabilizing element 4 forms a handling zone 11, which extends over an edge of the insertion flange 2, wherein, by applying a torque to the handling zone 11, the stabilizing element 4 can be adjusted between locked positions, in which the stabilizing flank arrangement 25 is in an angular position, which provides for an insertion of the free ends of slide bars 15.

A variable clamp adapter, which is characterized in that a cylindrical bearing surface 10 and a cylinder portion 27 adjoin the handling zone 11 of the rotatable stabilizing element 4.

A variable clamp adapter, which is characterized in that the cylinder portion 27 has several locking depressions 9, which are spaced apart from one another in an even angular distribution in the circumferential direction and with which hooks 8 arranged on the inner side of the bearing recess 3 can engage in an elastically resettable manner, wherein the edge of the cylinder portion 27 facing in the direction of the housing 1 forms an abutment shoulder 12, which, in conjunction with the hooks 8, prevents a pull-out of the stabilizing element 4 from the bearing recess 3.

A variable clamp adapter, which is characterized in that by a stabilizing ring 33, in particular a C-shaped snap ring, which engages around the hooks 8 and the bearing recess 3 so that they cannot unintentionally release from the locking with the locking depressions.

A variable clamp adapter, which is characterized in that the stabilizing element 4 forms a cavity 28, which adjoins the insertion opening 5 and which is open on both sides, through which the free end of the slide bar 15 can be guided and which has an inner wall 29, which is formed so as to correspond to the outline contour of the stabilizing flank arrangement 25, wherein the stabilizing flank arrangement 25 extends at least over a part of the axial length of the inner wall 29.

A variable clamp adapter, which is characterized in that the front side of the stabilizing element 4 has markings 32, which are assigned to different stabilizing flanks 25.

All of the disclosed features (alone, but also in combination with one another) are essential for the invention. The disclosure content of the corresponding/enclosed priority documents (copy of the prior application) is herewith also included in its entirety in the disclosure of the application, also for the purpose of adding features of these documents into claims of the present application. With their features, the subclaims characterize, even without the features of a referenced claim, separate inventive further developments of the prior art, in particular in order to file divisional applications on the basis of these claims.

The invention specified in each claim can additionally have one or several of the features, which are in particular provided with reference numerals in the above description and/or which are specified in the list of reference numerals. The invention also relates to designs, in the case of which individual features of the features mentioned in the above description are not realized, in particular insofar as they are evidently dispensable for the respective intended purpose or can be replaced by other technically equivalent means.

### LIST OF REFERENCE NUMERALS

1 housing
2 insertion flange
3 bearing recess
4 stabilizing element arrangement
5 insertion opening
6 insertion channel
7 lock element
8 hooks
9 locking depressions
10 cylindrical bearing surface
11 handling zone
12 abutment shoulder
13 narrow side flank
13′ narrow side flank
13″ narrow side flank
14 broadside flank
14′ broadside flank
14″ broadside flank
15 slide bar
15″ narrow side
15″ broadside
16 opening
17 protrusion
18 slot
19 pressure element
20 spring element
21 actuating pin
22 carrier
23 recess
24 recess
25 stabilizing flank
26 transition region
27 cylinder portion
28 cavity
29 inner wall
30 lug
31 bottom web
32 markings
33 stabilizing ring
34 circumferential groove
35 run-on slopes
36 stop surface
37 clamping jaw
38 protrusion
39 broadside wall
40 narrow side wall
b width
b′ width
b″ width
l length
l′ length
l″ length

1. A device with comprising:
a housing (1), which has an insertion channel (6) running in an axial direction for inserting a free end of a slide bar (15) of a clamp,
a lock element (7) configured for axially securing the slide bar (15) to the housing (1), the lock bar being configured to be be brought into a release position, in which the slide bar (15) can be removed from the device,
a stabilizing element (4) having an insertion opening (5) and and a stabilizing flank arrangement (25) adjoining the insertion opening, the stabilizing flank arrangement being adapted to the cross-section contour of the slide bar, for the abutment of supporting surface portions of the slide bar (15),
wherein the stabilizing element (4) has several stabilizing flank arrangements (25), which are adapted to different cross-section contours of slide bars (15) and which can optionally be brought into an aligned position with the insertion channel (6) of the housing (1).

2. The device according to claim 1, wherein the stabilizing element (4), is rotatably fastened to the housing (1), and wherein the several stabilizing flank arrangements (25) are angularly offset and are adapted to outline contours of different slide bars (15) and which delimit rectangular free surfaces with different widths (b, b′, b″) and lengths (l, l′, l″).

3. The device according to claim 1, wherein at least one of the stabilizing flank arrangement arrangements (25) forms narrow side flanks (13, 13′, 13″) and broadside flanks (14, 14′, 14″) for at least partially engaging around a narrow side (15′) of the slide bar (15).

4. The device according to claim 1, wherein at lease one of the stabilizing flank arrangements (25) is formed with a U-shaped cross section and two broadside flanks (14, 14′, 14″) running in parallel are in each case connected to a narrow side flank (13, 13′, 13″), wherein the broadside flanks (14, 14′, 14″) have broadside flank ends (26), which face the axis of the insertion opening (5) and which adjoin broadside flank ends (26) of adjacent stabilizing flank arrangements (25), wherein two stabilizing flank arrangements (25), which are located diametrically opposite one another, in each case engage around a narrow side (15′) and/or broadside (15″) of the slide bar (15).

5. The device according to claim 1, further comprising a flange, on which the stabilizing element (4) is rotatably mounted, the flange being an insertion flange (2) with a bearing recess (3), into which a portion of the stabilizing element (4) is inserted, wherein the stabilizing element (4) is held in different rotational positions by means of locking means (8, 9, 12).

6. The device according to claim 5, wherein the stabilizing element (4) forms a handling zone (11), which extends over an edge of the insertion flange (2), wherein, by applying a torque to the handling zone (11), the stabilizing element (4) can be adjusted between locked positions, in which at least one of the stabilizing flank arrangements (25) is in an angular position, which provides for an insertion of the free ends of slide bars (15).

7. The device according to claim 6, wherein a cylindrical bearing surface (10) and a cylinder portion (27) adjoin the handling zone (11) of the rotatable stabilizing element (4).

8. The device according to claim 7, wherein the cylinder portion (27) has several locking depressions (9), which are spaced apart from one another in an even angular distribution in the circumferential direction and with which hooks (8) arranged on the inner side of the bearing recess (3) are engageable in an elastically resettable manner, wherein an edge of the cylinder portion (27) facing in the direction of the housing (1) forms an abutment shoulder (12), which, in conjunction with the hooks (8), prevents a pull-out of the stabilizing element (4) from the bearing recess (3).

9. The device according to claim 8, further comprising a stabilizing ring (33), which engages around the hooks (8) and the bearing recess (3), so that the hooks cannot unintentionally release from locking with the locking depressions (9).

10. The device according to claim 1, wherein the stabilizing element (4) forms a cavity (28), which adjoins the insertion opening (5) and which is open on both sides, through which the free end of the slide bar (15) can be guided and which has an inner wall (29), which is formed so as to correspond to the outline contour of at least one of the stabilizing flank arrangements (25), wherein the at least one stabilizing flank arrangement (25) extends at least over a part of an axial length of the inner wall (29).

11. The device according to claim 1, wherein a front side of the stabilizing element (4) has markings (32), which are assigned to different stabilizing flanks (25).

12. (canceled)
